(19) United States
(12) Patent Application Publication
(10) Pub. No.: US 2025/0180918 A1
(43) Pub. Date: Jun. 5, 2025

(54) MULTIFUNCTIONAL HEAD-MOUNTED DEVICE AND METHOD OF USING THE SAME

(71) Applicant: ASTI GLOBAL INC., TAIWAN, Taichung City (TW)

(72) Inventor: CHIEN-SHOU LIAO, Taichung City (TW)

(21) Appl. No.: 18/963,775

(22) Filed: Nov. 29, 2024

Related U.S. Application Data
(60) Provisional application No. 63/605,060, filed on Dec. 1, 2023.

(51) Int. Cl. G02B 27/01; G02B 27/00

(52) U.S. Cl. CPC G02B 27/0176; G02B 27/0172; G02B 27/0093; G02B 2027/0138; G02B 2027/014; G02B 2027/0178

(57) ABSTRACT

A multifunctional head-mounted device and a method of using the same are provided. The multifunctional head-mounted device includes a device casing module, a signal control module, a first image generating module and a second image generating module. The device casing module includes a first eyeglass frame structure, a second eyeglass frame structure, a first eyeglass lens structure and a second eyeglass lens structure. The signal control module is disposed in the device casing module. The first image generating module is configured for cooperating with the device casing module. The second image generating module is configured for cooperating with the device casing module. The first image generating module includes a plurality of first image generating chips configured to surround the first eyeglass lens structure, and the second image generating module includes a plurality of second image generating chips configured to surround the second eyeglass lens structure.

CROSS-REFERENCE TO RELATED PATENT APPLICATION

This application claims the benefit of priority to the U.S. Provisional Patent Application Ser. No. 63/605,060, filed on Dec. 1, 2023, which application is incorporated herein by reference in its entirety.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a head-mounted device and a method of using the same, and more particularly to a multifunctional head-mounted device and a method of using the multifunctional head-mounted device.

### BACKGROUND OF THE DISCLOSURE

In the related art, AR or VR multifunctional head-mounted devices can provide users with different visual experiences. However, the AR or VR multifunctional head-mounted devices in the related art still have room for improvement.

### SUMMARY OF THE DISCLOSURE

In response to the above-referenced technical inadequacy, the present disclosure provides a multifunctional head-mounted device and a method of using the same, which can provide image-related signals to the user's left and right eyes in real time, and can also track the eyeball positions of the left eye and the right eye of the user in real time.

In order to solve the above-mentioned problems, one of the technical aspects adopted by the present disclosure is to provide a multifunctional head-mounted device, which includes a device casing module, a signal control module, a first image generating module and a second image generating module. The device casing module includes a first eyeglass frame structure, a second eyeglass frame structure cooperating with the first eyeglass frame structure, a first eyeglass lens structure carried by the first eyeglass frame structure, and a second eyeglass lens structure carried by the second eyeglass frame structure. The signal control module is disposed in the device casing module. The first image generating module is configured for cooperating with the device casing module and electrically connected to the signal control module. The second image generating module is configured for cooperating with the device casing module and electrically connected to the signal control module. The first image generating module includes a plurality of first image generating chips, and the plurality of first image generating chips are configured to surround the first eyeglass lens structure and be surrounded by the first eyeglass frame structure. The second image generating module includes a plurality of second image generating chips, and the plurality of second image generating chips are configured to surround the second eyeglass lens structure and be surrounded by the second eyeglass frame structure. When the multifunctional head-mounted device is optionally configured to be worn by a user, the plurality of first image generating chips are allowed to be configured through the signal control module to project a first predetermined image beam onto a first eye of the user through a first optical waveguide channel provided by the first eyeglass lens structure. When the multifunctional head-mounted device is optionally configured to be worn by the user, the plurality of second image generating chips are allowed to be configured through the signal control module to project a second predetermined image beam onto a second eye of the user through a second optical waveguide channel provided by the second eyeglass lens structure.

In order to solve the above-mentioned problems, another one of the technical aspects adopted by the present disclosure is to provide a multifunctional head-mounted device, which includes a device casing module, a signal control module, a first image generating module and a second image generating module. The device casing module includes a first eyeglass frame structure, a second eyeglass frame structure cooperating with the first eyeglass frame structure, a first eyeglass lens structure carried by the first eyeglass frame structure, and a second eyeglass lens structure carried by the second eyeglass frame structure. The signal control module is disposed in the device casing module. The first image generating module is configured for cooperating with the device casing module and electrically connected to the signal control module. The second image generating module is configured for cooperating with the device casing module and electrically connected to the signal control module. The first image generating module includes a plurality of first image generating chips configured to surround the first eyeglass lens structure, and the second image generating module includes a plurality of second image generating chips configured to surround the second eyeglass lens structure.

In order to solve the above-mentioned problems, yet another one of the technical aspects adopted by the present disclosure is to provide a method of using a multifunctional head-mounted device, which includes: providing a multifunctional head-mounted device, in which the multifunctional head-mounted device includes a device casing module, a signal control module disposed in the device casing module, a first image generating module electrically connected to the signal control module, and a second image generating module electrically connected to the signal control module; projecting a first predetermined image beam generated by the first image generating module onto a first eye of a user through an optical waveguide transmission provided by the device casing module; and projecting a second predetermined image beam generated by the second image generating module onto a second eye of the user through the optical waveguide transmission provided by the device casing module. The device casing module includes a first eyeglass frame structure, a second eyeglass frame structure cooperating with the first eyeglass frame structure, a first eyeglass lens structure carried by the first eyeglass frame structure, and a second eyeglass lens structure carried by the second eyeglass frame structure. The first image generating module includes a plurality of first image generating chips, and the plurality of first image generating chips are configured to surround the first eyeglass lens structure and be surrounded by the first eyeglass frame structure. The second image generating module includes a plurality of second image generating chips, and the plurality of second image generating chips are configured to surround the second eyeglass lens structure and be surrounded by the second eyeglass frame structure. When the multifunctional head-mounted device is optionally configured to be worn by the user, the plurality of first image generating chips are allowed to be configured through the signal control module to project the first predetermined image beam onto the first eye of the user through a first optical waveguide channel provided by the first eyeglass lens structure. When the multifunctional head-mounted device is optionally configured to be worn by the user, the plurality of second image generating chips are allowed to be configured through the signal control module to project the second predetermined image beam onto the second eye of the user through a second optical waveguide channel provided by the second eyeglass lens structure.

Therefore, in the multifunctional head-mounted device provided by the present disclosure, by virtue of “the first image generating module including a plurality of first image generating chips to surround the first eyeglass lens structure” and “the second image generating module including a plurality of second image generating chips to surround the second eyeglass lens structure,” when the multifunctional head-mounted device is optionally configured to be worn by a user, the plurality of first image generating chips are allowed to be configured through the signal control module to project a first predetermined image beam onto a first eye of the user through a first optical waveguide channel provided by the first eyeglass lens structure, and the plurality of second image generating chips are allowed to be configured through the signal control module to project a second predetermined image beam onto a second eye of the user through a second optical waveguide channel provided by the second eyeglass lens structure, thereby providing image-related signals to the user's left and right eyes in real time.

Furthermore, in the method of using the multifunctional head-mounted device provided by the present disclosure, by virtue of “projecting a first predetermined image beam generated by the first image generating module onto a first eye of a user through an optical waveguide transmission provided by the device casing module” and “projecting a second predetermined image beam generated by the second image generating module onto a second eye of the user through the optical waveguide transmission provided by the device casing module,” when the multifunctional head-mounted device is optionally configured to be worn by the user, the plurality of first image generating chips are allowed to be configured through the signal control module to project the first predetermined image beam onto the first eye of the user through a first optical waveguide channel provided by the first eyeglass lens structure, and the plurality of second image generating chips are allowed to be configured through the signal control module to project the second predetermined image beam onto the second eye of the user through a second optical waveguide channel provided by the second eyeglass lens structure, thereby providing image-related signals to the user's left and right eyes in real time.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of a multifunctional head-mounted device according to an embodiment of the present disclosure;

FIG. 2 is a schematic perspective view of the multifunctional head-mounted device according to the embodiment of the present disclosure;

FIG. 3 is another schematic perspective view of the multifunctional head-mounted device according to the embodiment of the present disclosure;

FIG. 4 is a schematic exploded cross-sectional view of a first part (which is applied to the user's right eye area) or a second part (which is applied to the user's left eye area) of the multifunctional head-mounted device according to the embodiment of the present disclosure;

FIG. 5 is a schematic assembled cross-sectional view of the first part (which is applied to the user's right eye area) or the second part (which is applied to the user's left eye area) of the multifunctional head-mounted device according to the embodiment of the present disclosure;

FIG. 6 is a schematic view of the multifunctional head-mounted device that can be configured to capture the user's eyeball images through an external light source according to the embodiment of the present disclosure;

FIG. 7 is a schematic view of the multifunctional head-mounted device that can be configured to capture the user's eyeball images through a first projection beam or a second projection beam according to the embodiment of the present disclosure;

FIG. 8 is a schematic view of the multifunctional head-mounted device providing image-related signals to the user through the first predetermined image beam or the second predetermined image beam according to the embodiment of the present disclosure;

FIG. 9 is a schematic view of the first image capturing module and the first image generating module arranged on the first circuit substrate (or the second image capturing module and the second image generating module arranged on the second circuit substrate) according to the embodiment of the present disclosure; and

FIG. 10 is a flowchart of a method of using the multifunctional head-mounted device provided by the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

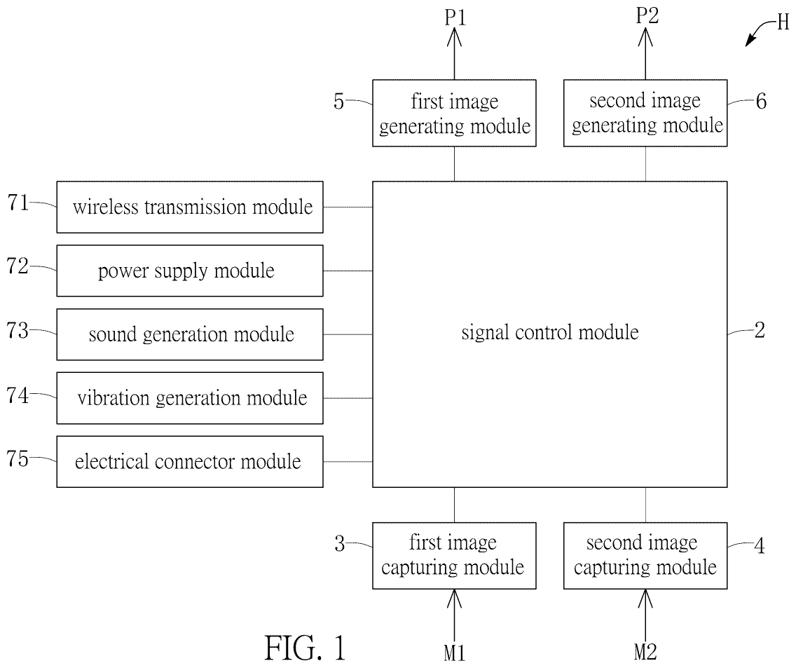

Referring to FIG. 1 to FIG. 9, in one of the feasible embodiments, the present disclosure provides a multifunctional head-mounted device H, which includes a device casing module 1, a signal control module 2, a first image capturing module 3 and a second image capturing module 4. More particularly, the device casing module 1 includes a first eyeglass frame structure 11, a second eyeglass frame structure 12 cooperating with the first eyeglass frame structure 11, a first eyeglass lens structure 13 carried or held by the first eyeglass frame structure 11, and a second eyeglass lens structure 14 carried or held by the second eyeglass frame structure 12. The signal control module 2 is disposed in the device casing module 1. The first image capturing module 3 can be configured to cooperate with the device casing module 1 and electrically connect to the signal control module 2, and the first image capturing module 3 includes a plurality of first image sensors 30 disposed on the first eyeglass frame structure 11. The second image capturing module 4 can be configured to cooperate with the device casing module 1 and electrically connect to the signal control module 2, and the second image capturing module 4 includes a plurality of second image sensors 40 disposed on the second eyeglass frame structure 12. Therefore, when the multifunctional head-mounted device H is optionally configured to be worn by the user, the first image sensors 30 can be allowed to capture the first eyeball image M1 of the first eye E1 of the user through a first optical waveguide channel 1300 provided by the first eyeglass lens structure 13, and the second image sensors 40 can be allowed to be configured to capture the second eyeball image M2 of the second eye E2 of the user through a second optical waveguide channel 1400 provided by the second eyeglass lens structure 14, thereby tracking the eyeball positions of the user's left and right eyes in real time.

Referring to FIG. 1 to FIG. 9, in one of the feasible embodiments, the present disclosure provides a multifunctional head-mounted device H, which includes a device casing module 1, a signal control module 2, a first image generating module 5 and a second image generating module 6. More particularly, the device casing module 1 includes a first eyeglass frame structure 11, a second eyeglass frame structure 12 cooperating with the first eyeglass frame structure 11, a first eyeglass lens structure 13 carried by the first eyeglass frame structure 11, and a second eyeglass lens structure 14 carried by the second eyeglass frame structure 12. The signal control module 2 is disposed in the device casing module 1. The first image generating module 5 can cooperate with the device casing module 1 and be electrically connected to the signal control module 2, and the first image generating module 5 includes a plurality of first image generating chips 50 that can be configured to surround the first eyeglass lens structure 13 and be surrounded by the first eyeglass frame structure 11. The second image generating module 6 can cooperate with the device casing module 1 and be electrically connected to the signal control module 2, and the second image generating module 6 includes a plurality of second image generating chips 60 that can be configured to surround the second eyeglass lens structure 14 and be surrounded by the second eyeglass frame structure 12. Therefore, when the multifunctional head-mounted device H is optionally configured to be worn by a user, the first image generating chips 50 can be allowed to be configured through the signal control module 2 to project a first predetermined image beam C1 onto a first eye E1 of the user through a first optical waveguide channel 1300 provided by the first eyeglass lens structure 13, and the second image generating chips 60 can be allowed to be configured through the signal control module 2 to project a second predetermined image beam C2 onto a second eye E2 of the user through a second optical waveguide channel 1400 provided by the second eyeglass lens structure 14, thereby providing image-related signals to the user's left and right eyes in real time.

### First Embodiment

Referring to FIG. 1 to FIG. 9, a first embodiment of the present disclosure provides a multifunctional head-mounted device H, which includes a device casing module 1, a signal control module 2, a first image capturing module 3 and a second image capturing module 4. For example, the multifunctional head-mounted device H can be the eyeglasses, so that the device casing module 1 can be an eyeglass casing structure. In one of the feasible embodiment, the multifunctional head-mounted device H can be a goggle worn by the user when exercising or working, a swimming goggle, a snow goggle, a pilot goggle, a firefighter goggle, a military goggle, a medical goggle or any type of multifunctional head-mounted device. However, the aforementioned details are disclosed for exemplary purposes only, and are not meant to limit the scope of the present disclosure.

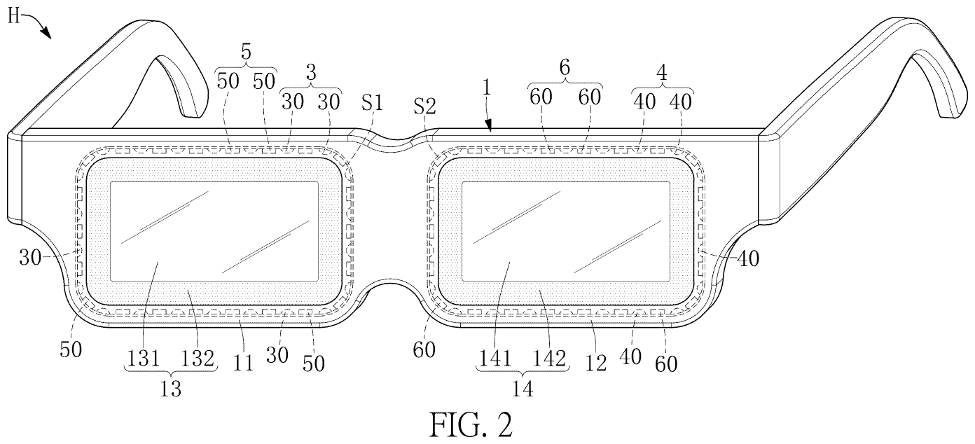

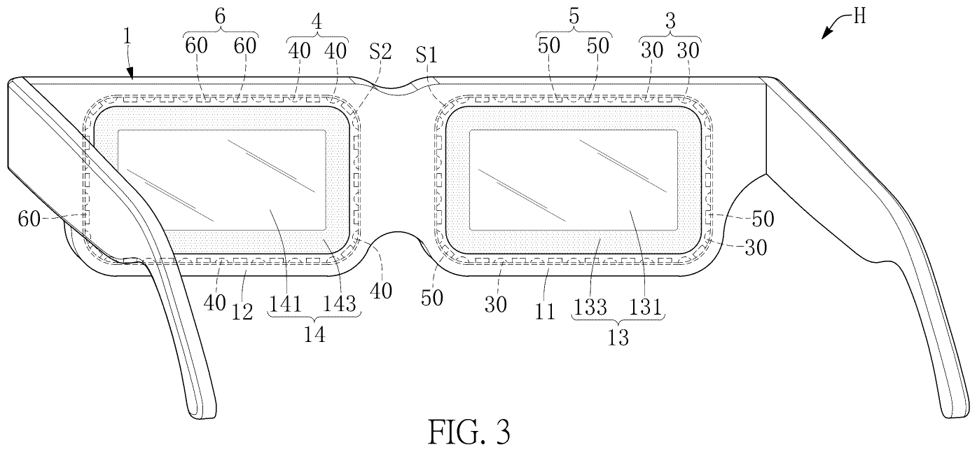

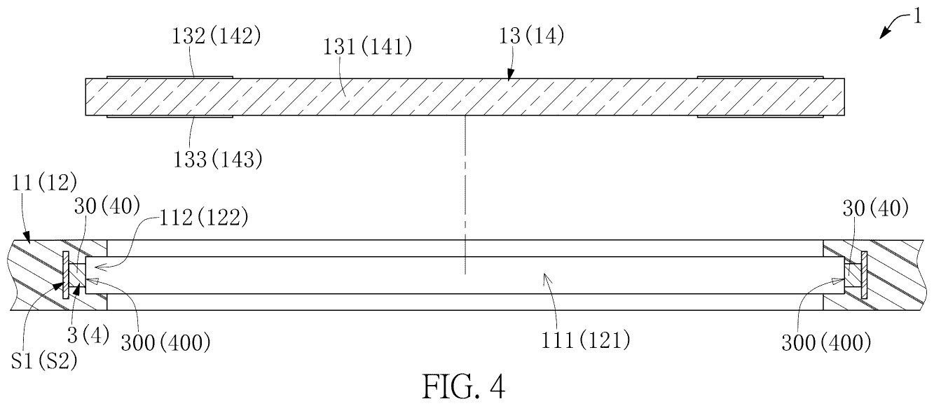

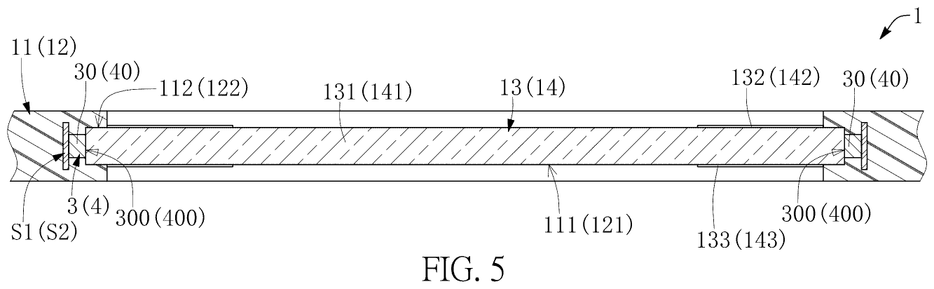

More particularly, referring to FIG. 2, FIG. 3, FIG. 4 and FIG. 5, when the multifunctional head-mounted device H serves as the eyeglasses, the device casing module 1 includes a first eyeglass frame structure 11 (or a right eyeglass frame structure), a second eyeglass frame structure 12 (or a left eyeglass frame structure) cooperating with the first eyeglass frame structure 11, a first eyeglass lens structure 13 (or a right eyeglass lens structure) carried or held by the first eyeglass frame structure 11, and a second eyeglass lens structure 14 (or a left eyeglass lens structure) carried or held by the second eyeglass frame structure 12. For example, the first eyeglass frame structure 11 has a first lens accommodating space 111 and a first surrounding groove 112 communicated with (in air communication with) the first lens accommodating space 111, and the first eyeglass lens structure 13 can be detachably accommodated in the first lens accommodating space 111 and limited (or restricted) by the first surrounding groove 112. Moreover, the second eyeglass frame structure 12 has a second lens accommodating space 121 and a second surrounding groove 122 communicated with (in air communication with) the second lens accommodating space 121, and the second eyeglass lens structure 14 can be detachably accommodated in the second lens accommodating space 121 and limited (or restricted) by the second surrounding groove 122. Moreover, the first eyeglass lens structure 13 includes a first lens 131 (such as a first optical lens with or without prescription), a first external reflective layer 132 disposed on a first outer surface (or a first outer surface facing away from the user) of the first lens 131, and a first internal reflective layer 133 disposed on a first inner surface (or a first inner surface facing the user) of the first lens 131. In addition, the second eyeglass lens structure 14 includes a second lens 141 (such as a second optical lens with or without prescription), a second external reflective layer 142 disposed on a second outer surface (or a second outer surface facing away from the user) of the second lens 141, and a second internal reflective layer 143 disposed on a second inner surface (or a second inner surface facing the user) of the second lens 141. It should be noted that the device casing module 1 may further include a first temple leg (or a first temple structure) that can cooperate with the first eyeglass frame structure 11 and a second temple leg (or a second temple structure) that can cooperate with the second eyeglass frame structure 12. However, the aforementioned details are disclosed for exemplary purposes only, and are not meant to limit the scope of the present disclosure.

More particularly, referring to FIG. 1, FIG. 2 and FIG. 5, the signal control module 2 is disposed in the device casing module 1, the first image capturing module 3 can be configured to cooperate with the device casing module 1 (for example, the first image capturing module 3 can be detachably disposed on the device casing module 1) and electrically connect to the signal control module 2, and the second image capturing module 4 can be configured to cooperate with the device casing module 1 (for example, the second image capturing module 4 can be detachably disposed on the device casing module 1) and electrically connect to the signal control module 2. For example, the signal control module 2 can use a central processing unit (CPU), a digital signal processor (DSP), a microprocessor (MPU), a microcontroller (MCU) or any type of control chip with any type of memory. Moreover, the first image capturing module 3 includes a plurality of first image sensors 30 that can be made through a semiconductor process and disposed around the first eyeglass frame structure 11 (that is to say, the first image sensors 30 can be configured to surround the first eyeglass lens structure 13 and be surrounded by the first eyeglass frame structure 11), the first image sensors 30 can be surroundingly arranged inside or outside the first surrounding groove 112, and each of the first image sensors 30 has a first sensing area 300 facing the first lens 131 of the first eyeglass lens structure 13. Moreover, the second image capturing module 4 includes a plurality of second image sensors 40 that can be made through a semiconductor process and disposed around the second eyeglass frame structure 12 (that is to say, the second image sensors 40 can be configured to surround the second eyeglass lens structure 14 and be surrounded by the second eyeglass frame structure 12), the second image sensors 40 can be surroundingly arranged inside or outside of the second surrounding groove 122, and each of the second image sensors 40 has a second sensing area 400 facing the second lens 141 of the second eyeglass lens structure 14. In addition, the first image capturing module 3 and the second image capturing module 4 can be charge-coupled device (CCD) image sensors, complementary metal oxide semiconductor (CMOS) image sensors, or any type of image sensor (or any type of image sensor chip). It should be noted that in a feasible embodiment, some of the plurality of first image sensors 30 can be configured as a plurality of first biosensor chips (or at least one or more first biosensing chips), and some of the plurality of second image sensors 40 can be configured as a plurality of second biosensor chips (or at least one or more second biosensing chips), thereby capturing image information (such as pupil images, eyelid images, or scleral images, which can be used to provide relevant position information or microvascular feature information) of the user's eyeballs, and the user's eyeball image information can be transmitted to the cloud database through wired or wireless transmission methods for relevant bioanalysis and data comparison, thereby obtaining the user's relevant physiological information. Moreover, the first image sensors 30 can be sequentially arranged on a first circuit substrate S1 to surround the first lens 131 of the first eyeglass lens structure 13, and the first circuit substrate S1 can be circumferentially disposed inside or outside the first surrounding groove 112. In addition, the second image sensors 40 can be sequentially arranged on a second circuit substrate S2 to surround the second lens 141 of the second eyeglass lens structure 14, and the second circuit substrate S2 can be circumferentially disposed inside or outside the second surrounding groove 122. However, the aforementioned details are disclosed for exemplary purposes only, and are not meant to limit the scope of the present disclosure.

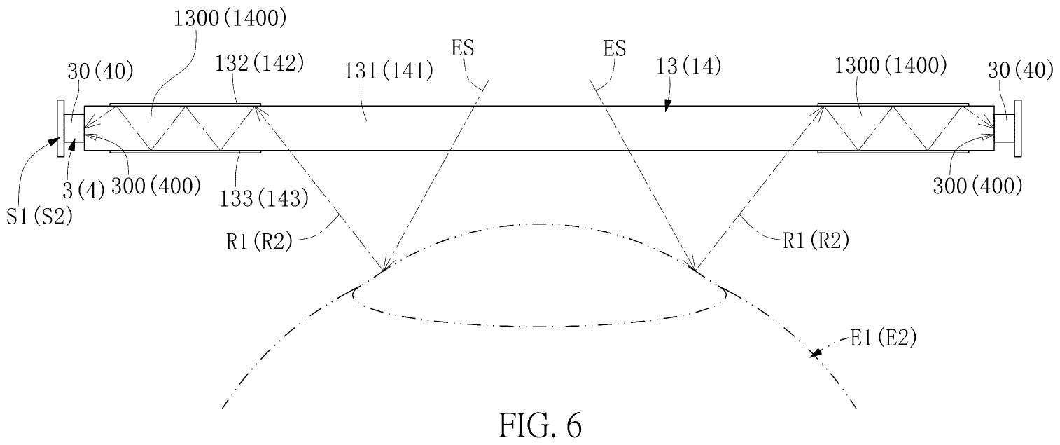

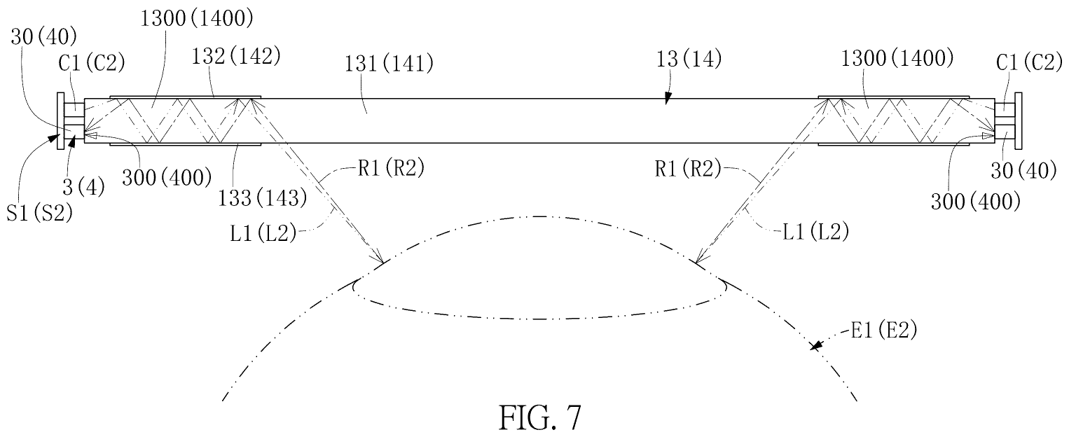

Therefore, referring to FIG. 1, FIG. 5, FIG. 6 and FIG. 7, when the multifunctional head-mounted device H is optionally configured to be worn by a user, the first image sensors 30 can be allowed to be configured through the signal control module 2 to capture or obtain a first eyeball image M1 (a right eyeball image) of a first eye E1 of the user through a first optical waveguide channel 1300 (or a first light transmission channel, or a first reflective diffraction optical channel) provided by the first eyeglass lens structure 13, and the second image sensors 40 can be allowed to be configured through the signal control module 2 to capture or obtain a second eyeball image M2 (a left eyeball image) of a second eye E2 of the user through a second optical waveguide channel 1400 (or a second light transmission channel, or a second reflective diffraction optical channel) provided by the second eyeglass lens structure 14, thereby tracking the eyeball positions of the left eye and the right eye of the user in real time. More particularly, when the first image sensors 30 can be configured to capture the first eyeball image M1 of the first eye E1 of the user, a first eyeball reflected light R1 (or a plurality of first eyeball reflected beams R1) generated from or by the first eye E1 can be reflected multiple times between the first external reflective layer 132 and the first internal reflective layer 133 of the first eyeglass lens structure 13 (or can be transmitted within the first optical waveguide channel 1300) and then is projected onto the first image sensors 30. In addition, when the second image sensors 40 can be configured to capture the second eyeball image M2 of the second eye E2 of the user, a second eyeball reflected light R2 (or a plurality of second eyeball reflected beams R2) generated from the second eye E2 can be reflected multiple times between the second external reflective layer 142 and the second internal reflective layer 143 of the second eyeglass lens structure 14 (or can be transmitted within the second optical waveguide channel 1400) and then is projected onto the second image sensors 40. Therefore, the present disclosure can not only reduce the overall volume of the multifunctional head-mounted device H, but also reduce the loss generated during light transmission (or increase the light transmission efficiency).

For example, referring to FIG. 1, FIG. 5, FIG. 6 and FIG. 7, when the first image sensors 30 can be configured to capture the first eyeball image M1 of the first eye E1 of the user, an external light source ES (such as ambient light as shown in FIG. 6) or a first projection beam L1 (or a plurality of first projection beams L1) provided by a plurality of first light-emitting chips C1 (such as a plurality of first LED chips or a plurality of first infrared LED chips arranged surroundingly) of the multifunctional head-mounted device H (as shown in FIG. 7) can be reflected by the first eye E1 to generate a first eyeball reflected light R1 (or a plurality of first eyeball reflected beams R1), and the first eyeball reflected light R1 can be reflected multiple times between the first external reflective layer 132 and the first internal reflective layer 133 of the first eyeglass lens structure 13 (or can be transmitted within the first optical waveguide channel 1300) and then is projected onto the first image sensors 30. In addition, when the second image sensors 40 can be configured to capture the second eyeball image M2 of the second eye E2 of the user, the external light source ES (as shown in FIG. 6) or a second projection beam L2 (or a plurality of second projection beams L2) provided by a plurality of second light-emitting chips C2 (such as a plurality of second LED chips or a plurality of second infrared LED chips arranged surroundingly) of the multifunctional head-mounted device H (as shown in FIG. 7) can be reflected by the second eye E2 to generate a second eyeball reflected light R2, and the second eyeball reflected light R2 (or a plurality of second eyeball reflected beams R2) can be reflected multiple times between the second external reflective layer 142 and the second internal reflective layer 143 of the second eyeglass lens structure 14 (or can be transmitted within the second optical waveguide channel 1400) and then is projected onto the second image sensors 40. However, the aforementioned details are disclosed for exemplary purposes only, and are not meant to limit the scope of the present disclosure.

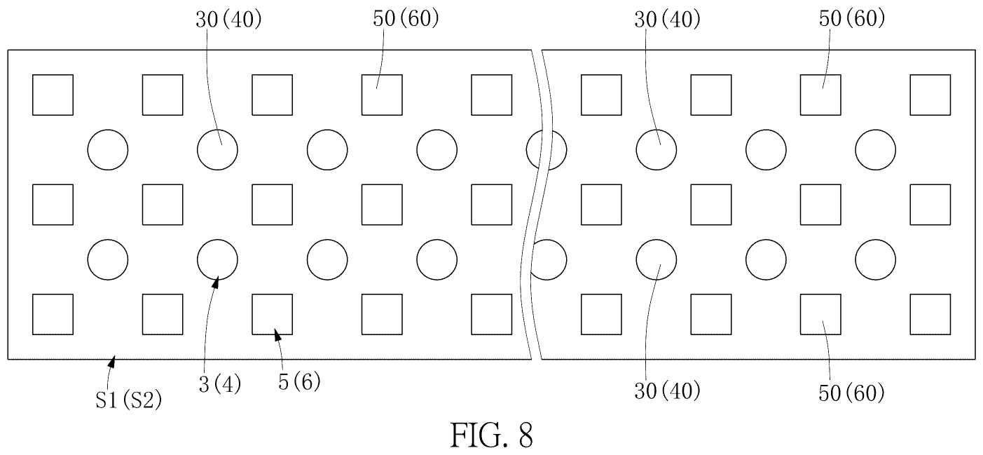

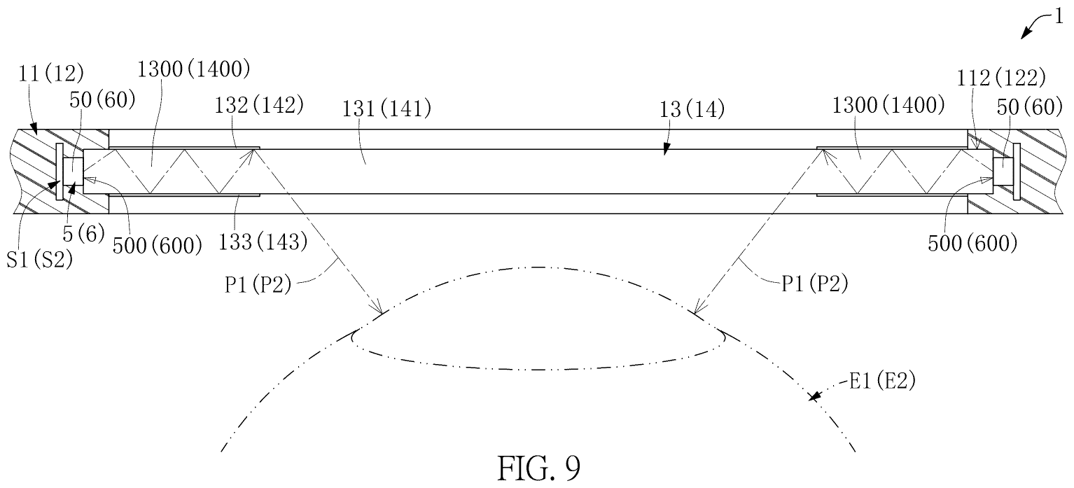

More particularly, referring to FIG. 1, FIG. 2, FIG. 8 and FIG. 9, the multifunctional head-mounted device H provided by the first embodiment of the present disclosure further includes a first image generating module 5 and a second image generating module 6. Moreover, the first image generating module 5 can cooperate with the device casing module 1 and be electrically connected to the signal control module 2, the first image generating module 5 includes a plurality of first image generating chips 50 (or a plurality of first light-emitting chips), and the plurality of first image generating chips 50 can be configured to surround the first eyeglass lens structure 13 and be surrounded by the first eyeglass frame structure 11. In addition, the second image generating module 6 can cooperate with the device casing module 1 and be electrically connected to the signal control module 2, the second image generating module 6 includes a plurality of second image generating chips 60 (or a plurality of second light-emitting chips), and the plurality of second image generating chips 60 can be configured to surround the second eyeglass lens structure 14 and be surrounded by the second eyeglass frame structure 12. For example, the first image generating chips 50 (such as a plurality of first LED chips) can be made through a semiconductor process and sequentially arranged on a first circuit substrate S1 to surround the first lens 131 of the first eyeglass lens structure 13, the first image generating chips 50 can be surroundingly arranged inside or outside the first surrounding groove 112, and each of the first image generating chips 50 has a first light-emitting area 500 facing the first lens 131 of the first eyeglass lens structure 13. In addition, the second image generating chips 60 (such as a plurality of second LED chips) can be made through a semiconductor process and sequentially arranged on a second circuit substrate S2 to surround the second lens 141 of the second eyeglass lens structure 14, the second image generating chips 60 can be surroundingly arranged inside or outside the second surrounding groove 122, and each of the second image generating chips 60 has a second light-emitting area 600 facing the second lens 141 of the second eyeglass lens structure 14. However, the aforementioned details are disclosed for exemplary purposes only, and are not meant to limit the scope of the present disclosure.

Therefore, referring to FIG. 1, FIG. 2 and FIG. 9, when the multifunctional head-mounted device H is optionally configured to be worn by a user, the plurality of first image generating chips 50 are allowed to be configured through the signal control module 2 to project a first predetermined image beam P1 (a plurality of first predetermined image beams P1) onto a first eye E1 of the user through a first optical waveguide channel 1300 provided by the first eyeglass lens structure 13. In addition, when the multifunctional head-mounted device H is optionally configured to be worn by the user, the plurality of second image generating chips 60 are allowed to be configured through the signal control module 2 to project a second predetermined image beam P2 (a plurality of second predetermined image beams P2) onto a second eye E2 of the user through a second optical waveguide channel 1400 provided by the second eyeglass lens structure 14. More particularly, when the first image generating chips 50 are configured to project the first predetermined image beam P1 onto the first eye E1 of the user, the first predetermined image beam P1 generated by the first image generating chips 50 can be reflected multiple times between the first external reflective layer 132 and the first internal reflective layer 133 of the first eyeglass lens structure 13 (or can be transmitted within the first optical waveguide channel 1300) and then be projected onto the first eye E1 of the user. In addition, when the second image generating chips 60 are configured to project the second predetermined image beam P2 onto the second eye E2 of the user, the second predetermined image beam P2 generated by the second image generating chips 60 can be reflected multiple times between the second external reflective layer 142 and the second internal reflective layer 143 of the second eyeglass lens structure 14 (or can be transmitted within the second optical waveguide channel 1400) and then is projected onto the second eye E2 of the user. Therefore, the present disclosure can not only reduce the overall volume of the multifunctional head-mounted device H, but also reduce the loss generated during light transmission (or increase the light transmission efficiency).

More particularly, referring to FIG. 1, FIG. 2 and FIG. 3, the multifunctional head-mounted device H provided by the first embodiment of the present disclosure further includes a wireless transmission module 71, a power supply module 72, a sound generation module 73, a vibration generation module 74 and an electrical connector module 75, and the wireless transmission module 71 (such as using an antenna structure or an antenna chip with Wi-Fi, Bluetooth, ZigBee or any wireless transmission method for wireless data transmission), the power supply module 72 (such as including any type of rechargeable battery or solar cell), the sound generation module 73 (such as including any kind of loudspeaker), the vibration generation module 74 (such as including a small vibration motor that can generate continuous or discontinuous vibrations, or generate high-frequency or low-frequency vibrations) and the electrical connector module 75 (such as including a USB interface or any kind of transmission interface) can be disposed inside the device casing module 1 (such as the inside of the first temple or the second temple) and electrically connected to the signal control module 2. However, the aforementioned details are disclosed for exemplary purposes only, and are not meant to limit the scope of the present disclosure.

### Second Embodiment

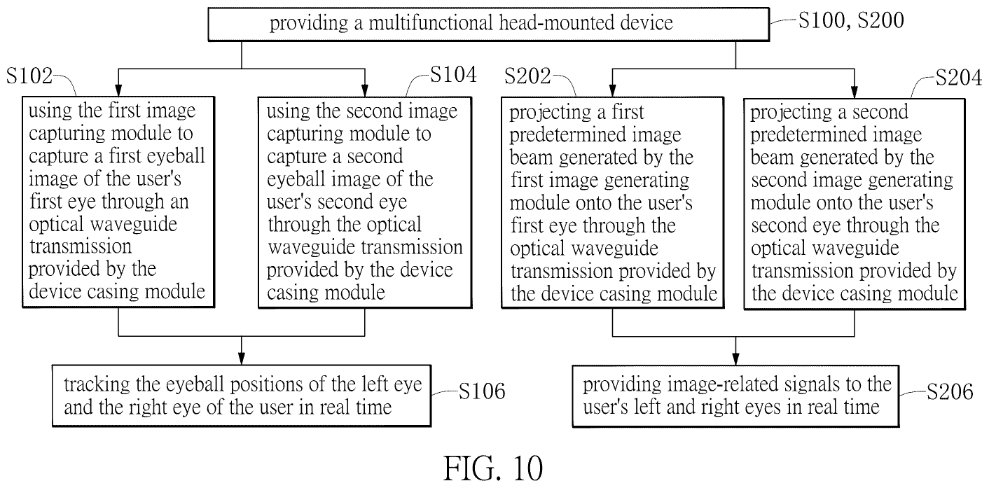

Referring to FIG. 1, FIG. 6, FIG. 7 and FIG. 10, a second embodiment of the present disclosure provides a method of using a multifunctional head-mounted device H, which includes: firstly, referring to FIG. 1 and FIG. 10, providing a multifunctional head-mounted device H (step S100), in which the multifunctional head-mounted device H includes a device casing module 1, a signal control module 2 disposed in the device casing module 1, a first image capturing module 3 electrically connected to the signal control module 2, and a second image capturing module 4 electrically connected to the signal control module 2; next, referring to FIG. 6, FIG. 7 and FIG. 10, using the first image capturing module 3 (including a plurality of first image sensors 30) to capture a first eyeball image M1 of a first eye E1 of a user through an optical waveguide transmission (such as a first optical waveguide transmission) provided by the device casing module 1 (step S102); and then referring to FIG. 6, FIG. 7 and FIG. 10, using the second image capturing module 4 (including a plurality of second image sensors 40) to capture a second eyeball image M2 of a second eye E2 of the user through another optical waveguide transmission (such as a second optical waveguide transmission) provided by the device casing module 1 (step S104). That is to say, when the multifunctional head-mounted device H is optionally configured to be worn by the user, the first image sensors 30 of the first image capturing module 3 can be allowed to be configured through the signal control module 2 to capture the first eyeball image M1 of the first eye E1 of the user through a first optical waveguide channel 1300 (or a first light transmission channel, or a first reflective diffraction optical channel) provided by the first eyeglass lens structure 13, and the second image sensors 40 of the second image capturing module 4 can be allowed to be configured through the signal control module 2 to capture the second eyeball image M2 of the second eye E2 of the user through a second optical waveguide channel 1400 (or a second light transmission channel, or a second reflective diffraction optical channel) provided by the second eyeglass lens structure 14, thereby tracking the eyeball positions of the left eye and the right eye of the user in real time (step S106).

More particularly, referring to FIG. 1, FIG. 9 and FIG. 10, the method of using the multifunctional head-mounted device H provided by the second embodiment of the present disclosure further includes: firstly, referring to FIG. 9 and FIG. 10, providing a multifunctional head-mounted device H (step S200), in which the multifunctional head-mounted device H includes a device casing module 1, a signal control module 2 disposed in the device casing module 1, a first image generating module 5 electrically connected to the signal control module 2, and a second image generating module 6 electrically connected to the signal control module 2; next, referring to FIG. 9 and FIG. 10, projecting a first predetermined image beam P1 generated by the first image generating module 5 (including a plurality of first image generating chips 50) onto a first eye E1 of a user through an optical waveguide transmission provided (such as a first optical waveguide transmission) by the device casing module 1 (step S202); then, referring to FIG. 9 and FIG. 10, projecting a second predetermined image beam P2 generated by the second image generating module 6 (including a plurality of second image generating chips 60) onto a second eye E2 of the user through another optical waveguide transmission (such as a second optical waveguide transmission) provided by the device casing module 1 (step S204). That is to say, when the multifunctional head-mounted device H is optionally configured to be worn by the user, the plurality of first image generating chips 50 of the first image generating module 5 are allowed to be configured through the signal control module 2 to project the first predetermined image beam P1 onto the first eye E1 of the user through a first optical waveguide channel 1300 (or a first light transmission channel, or a first reflective diffraction optical channel) provided by the first eyeglass lens structure 13, and the plurality of second image generating chips 60 of the second image generating module 6 are allowed to be configured through the signal control module 2 to project the second predetermined image beam P2 onto the second eye E2 of the user through a second optical waveguide channel 1400 (or a second light transmission channel, or a second reflective diffraction optical channel) provided by the second eyeglass lens structure 14, thereby providing image-related signals to the user's left and right eyes in real time (step S206).

### Beneficial Effects of the Embodiments

In conclusion, in the multifunctional head-mounted device H provided by the present disclosure, by virtue of “the first image generating module 5 including a plurality of first image generating chips 50 to surround the first eyeglass lens structure 13” and “the second image generating module 6 including a plurality of second image generating chips 60 to surround the second eyeglass lens structure 14,” when the multifunctional head-mounted device H is optionally configured to be worn by a user, the plurality of first image generating chips 50 are allowed to be configured through the signal control module 2 to project a first predetermined image beam P1 onto a first eye E1 of the user through a first optical waveguide channel 1300 provided by the first eyeglass lens structure 13, and the plurality of second image generating chips 60 are allowed to be configured through the signal control module 2 to project a second predetermined image beam P2 onto a second eye E2 of the user through a second optical waveguide channel 1400 provided by the second eyeglass lens structure 14, thereby providing image-related signals to the user's left and right eyes in real time. It should be noted that, in the multifunctional head-mounted device H provided by the present disclosure, by virtue of “the first image capturing module 3 including a plurality of first image sensors 30 disposed on the first eyeglass frame structure 11” and “the second image capturing module 4 including a plurality of second image sensors 40 disposed on the second eyeglass frame structure 12,” when the multifunctional head-mounted device H is optionally configured to be worn by the user, the first image sensors 30 can be allowed to capture the first eyeball image M1 of the first eye E1 of the user through a first optical waveguide channel 1300 provided by the first eyeglass lens structure 13, and the second image sensors 40 can be allowed to be configured to capture the second eyeball image M2 of the second eye E2 of the user through a second optical waveguide channel 1400 provided by the second eyeglass lens structure 14, thereby tracking the eyeball positions of the user's left and right eyes in real time.

Furthermore, in the method of using the multifunctional head-mounted device H provided by the present disclosure, by virtue of “projecting a first predetermined image beam P1 generated by the first image generating module 5 onto a first eye E1 of a user through an optical waveguide transmission provided by the device casing module 1” and “projecting a second predetermined image beam P2 generated by the second image generating module 6 onto a second eye E2 of the user through the optical waveguide transmission provided by the device casing module 1,” when the multifunctional head-mounted device H is optionally configured to be worn by the user, the plurality of first image generating chips 50 are allowed to be configured through the signal control module 2 to project the first predetermined image beam P1 onto the first eye E1 of the user through a first optical waveguide channel 1300 provided by the first eyeglass lens structure 13, and the plurality of second image generating chips 60 are allowed to be configured through the signal control module 2 to project the second predetermined image beam P2 onto the second eye E2 of the user through a second optical waveguide channel 1400 provided by the second eyeglass lens structure 14, thereby providing image-related signals to the user's left and right eyes in real time. It should be noted that, in the method of using the multifunctional head-mounted device H provided by the present disclosure, by virtue of “capturing the first eyeball image M1 of the first eye E1 of the user through the optical waveguide transmission provided by the device casing module 1” and “capturing the second eyeball image M2 of the second eye E2 of the user through the optical waveguide transmission provided by the device casing module 1,” when the multifunctional head-mounted device H is optionally configured to be worn by the user, the first image sensors 30 can be allowed to capture the first eyeball image M1 of the first eye E1 of the user through a first optical waveguide channel 1300 provided by the first eyeglass lens structure 13, and the second image sensors 40 can be allowed to be configured to capture the second eyeball image M2 of the second eye E2 of the user through a second optical waveguide channel 1400 provided by the second eyeglass lens structure 14, thereby tracking the eyeball positions of the user's left and right eyes in real time.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A multifunctional head-mounted device, comprising:
a device casing module including a first eyeglass frame structure, a second eyeglass frame structure cooperating with the first eyeglass frame structure, a first eyeglass lens structure carried by the first eyeglass frame structure, and a second eyeglass lens structure carried by the second eyeglass frame structure;
a signal control module disposed in the device casing module;
a first image generating module cooperating with the device casing module and electrically connected to the signal control module; and
a second image generating module cooperating with the device casing module and electrically connected to the signal control module;
wherein the first image generating module includes a plurality of first image generating chips, and the plurality of first image generating chips are configured to surround the first eyeglass lens structure and be surrounded by the first eyeglass frame structure;
wherein the second image generating module includes a plurality of second image generating chips, and the plurality of second image generating chips are configured to surround the second eyeglass lens structure and be surrounded by the second eyeglass frame structure;
wherein, when the multifunctional head-mounted device is optionally configured to be worn by a user, the plurality of first image generating chips are allowed to be configured through the signal control module to project a first predetermined image beam onto a first eye of the user through a first optical waveguide channel provided by the first eyeglass lens structure; and
wherein, when the multifunctional head-mounted device is optionally configured to be worn by the user, the plurality of second image generating chips are allowed to be configured through the signal control module to project a second predetermined image beam onto a second eye of the user through a second optical waveguide channel provided by the second eyeglass lens structure.

2. The multifunctional head-mounted device according to claim 1, further comprising:
a first image capturing module configured to cooperate with the device casing module and electrically connect to the signal control module;
a second image capturing module configured to cooperate with the device casing module and electrically connect to the signal control module;
a wireless transmission module disposed inside the device casing module and electrically connected to the signal control module;
a power supply module disposed inside the device casing module and electrically connected to the signal control module;
a sound generation module disposed inside the device casing module and electrically connected to the signal control module;
a vibration generation module disposed inside the device casing module and electrically connected to the signal control module; and
an electrical connector module disposed inside the device casing module and electrically connected to the signal control module;
wherein the first image capturing module includes a plurality of first image sensors configured to surround the first eyeglass lens structure and be surrounded by the first eyeglass frame structure, and some of the plurality of first image sensors are configured as a plurality of first biosensor chips;
wherein the second image capturing module includes a plurality of second image sensors configured to surround the second eyeglass lens structure and be surrounded by the second eyeglass frame structure, and some of the plurality of second image sensors are configured as a plurality of second biosensor chips;
wherein, when the multifunctional head-mounted device is optionally configured to be worn by the user, the first image sensors are allowed to be configured through the signal control module to capture a first eyeball image of the first eye of the user through the first optical waveguide channel provided by the first eyeglass lens structure; and
wherein, when the multifunctional head-mounted device is optionally configured to be worn by the user, the second image sensors are allowed to be configured through the signal control module to capture a second eyeball image of the second eye of the user through the second optical waveguide channel provided by the second eyeglass lens structure.

3. The multifunctional head-mounted device according to claim 2,
wherein the first eyeglass frame structure has a first lens accommodating space and a first surrounding groove communicated with the first lens accommodating space, and the first eyeglass lens structure is detachably accommodated in the first lens accommodating space and limited by the first surrounding groove;
wherein the second eyeglass frame structure has a second lens accommodating space and a second surrounding groove communicated with the second lens accommodating space, and the second eyeglass lens structure is detachably accommodated in the second lens accommodating space and limited by the second surrounding groove;
wherein the first eyeglass lens structure includes a first lens, a first external reflective layer disposed on a first outer surface of the first lens, and a first internal reflective layer disposed on a first inner surface of the first lens;
wherein the second eyeglass lens structure includes a second lens, a second external reflective layer disposed on a second outer surface of the second lens, and a second internal reflective layer disposed on a second inner surface of the second lens;
wherein, when the first image sensors are configured to capture the first eyeball image of the first eye of the user, the first eyeball reflected light generated from the first eye is reflected multiple times between the first external reflective layer and the first internal reflective layer of the first eyeglass lens structure and then is projected onto the first image sensors; and
wherein, when the second image sensors are configured to capture the second eyeball image of the second eye of the user, the second eyeball reflected light generated from the second eye is reflected multiple times between the second external reflective layer and the second internal reflective layer of the second eyeglass lens structure and then is projected onto the second image sensors.

4. The multifunctional head-mounted device according to claim 2,
wherein the first eyeglass frame structure has a first lens accommodating space and a first surrounding groove communicated with the first lens accommodating space, and the first eyeglass lens structure is detachably accommodated in the first lens accommodating space and limited by the first surrounding groove;
wherein the second eyeglass frame structure has a second lens accommodating space and a second surrounding groove communicated with the second lens accommodating space, and the second eyeglass lens structure is detachably accommodated in the second lens accommodating space and limited by the second surrounding groove;
wherein the first eyeglass lens structure includes a first lens, a first external reflective layer disposed on a first outer surface of the first lens, and a first internal reflective layer disposed on a first inner surface of the first lens;
wherein the second eyeglass lens structure includes a second lens, a second external reflective layer disposed on a second outer surface of the second lens, and a second internal reflective layer disposed on a second inner surface of the second lens;
wherein, the first image sensors are surroundingly arranged inside or outside the first surrounding groove, and each of the first image sensors has a first sensing area facing the first lens of the first eyeglass lens structure;
wherein, the second image sensors are surroundingly arranged inside or outside of the second surrounding groove, and each of the second image sensors has a second sensing area facing the second lens of the second eyeglass lens structure;
wherein the first image generating chips and the first image sensors are sequentially arranged on a first circuit substrate to surround the first lens of the first eyeglass lens structure, and the first circuit substrate is circumferentially disposed inside or outside the first surrounding groove;
wherein the second image generating chips and the second image sensors are sequentially arranged on a second circuit substrate to surround the second lens of the second eyeglass lens structure, and the second circuit substrate is circumferentially disposed inside or outside the second surrounding groove;
wherein, when the first image sensors are configured to capture the first eyeball image of the first eye of the user, an external light source or a first projection beam provided by the multifunctional head-mounted device is reflected by the first eye to generate a first eyeball reflected light, and the first eyeball reflected light is reflected multiple times between the first external reflective layer and the first internal reflective layer of the first eyeglass lens structure and then is projected onto the first image sensors; and
wherein, when the second image sensors are configured to capture the second eyeball image of the second eye of the user, the external light source or a second projection beam provided by the multifunctional head-mounted device is reflected by the second eye to generate a second eyeball reflected light, and the second eyeball reflected light is reflected multiple times between the second external reflective layer and the second internal reflective layer of the second eyeglass lens structure and then is projected onto the second image sensors.

5. The multifunctional head-mounted device according to claim 1,
wherein the first eyeglass frame structure has a first lens accommodating space and a first surrounding groove communicated with the first lens accommodating space, and the first eyeglass lens structure is detachably accommodated in the first lens accommodating space and limited by the first surrounding groove;
wherein the second eyeglass frame structure has a second lens accommodating space and a second surrounding groove communicated with the second lens accommodating space, and the second eyeglass lens structure is detachably accommodated in the second lens accommodating space and limited by the second surrounding groove;
wherein the first eyeglass lens structure includes a first lens, a first external reflective layer disposed on a first outer surface of the first lens, and a first internal reflective layer disposed on a first inner surface of the first lens;
wherein the second eyeglass lens structure includes a second lens, a second external reflective layer disposed on a second outer surface of the second lens, and a second internal reflective layer disposed on a second inner surface of the second lens;
wherein the first image generating chips are surroundingly arranged inside or outside the first surrounding groove, and each of the first image generating chips has a first light-emitting area facing the first lens of the first eyeglass lens structure;
wherein the second image generating chips are surroundingly arranged inside or outside the second surrounding groove, and each of the second image generating chips has a second light-emitting area facing the second lens of the second eyeglass lens structure;
wherein, when the first image generating chips are configured to project the first predetermined image beam onto the first eye of the user, the first predetermined image beam generated by the first image generating chips is reflected multiple times between the first external reflective layer and the first internal reflective layer of the first eyeglass lens structure and then is projected onto the first eye of the user; and
wherein, when the second image generating chips are configured to project the second predetermined image beam onto the second eye of the user, the second predetermined image beam generated by the second image generating chips is reflected multiple times between the second external reflective layer and the second internal reflective layer of the second eyeglass lens structure and then is projected onto the second eye of the user.

6. A multifunctional head-mounted device, comprising:
a device casing module including a first eyeglass frame structure, a second eyeglass frame structure cooperating with the first eyeglass frame structure, a first eyeglass lens structure carried by the first eyeglass frame structure, and a second eyeglass lens structure carried by the second eyeglass frame structure;
a signal control module disposed in the device casing module;
a first image generating module cooperating with the device casing module and electrically connected to the signal control module; and
a second image generating module cooperating with the device casing module and electrically connected to the signal control module;
wherein the first image generating module includes a plurality of first image generating chips configured to surround the first eyeglass lens structure, and the second image generating module includes a plurality of second image generating chips configured to surround the second eyeglass lens structure.

7. The multifunctional head-mounted device according to claim 6, further comprising:
a first image capturing module configured to cooperate with the device casing module and electrically connect to the signal control module;
a second image capturing module configured to cooperate with the device casing module and electrically connect to the signal control module;
a wireless transmission module disposed inside the device casing module and electrically connected to the signal control module;
a power supply module disposed inside the device casing module and electrically connected to the signal control module;
a sound generation module disposed inside the device casing module and electrically connected to the signal control module;
a vibration generation module disposed inside the device casing module and electrically connected to the signal control module; and
an electrical connector module disposed inside the device casing module and electrically connected to the signal control module;
wherein the first image capturing module includes a plurality of first image sensors configured to surround the first eyeglass lens structure and be surrounded by the first eyeglass frame structure, and some of the plurality of first image sensors are configured as a plurality of first biosensor chips;
wherein the second image capturing module includes a plurality of second image sensors configured to surround the second eyeglass lens structure and be surrounded by the second eyeglass frame structure, and some of the plurality of second image sensors are configured as a plurality of second biosensor chips;
wherein, when the multifunctional head-mounted device is optionally configured to be worn by a user, the first image sensors are allowed to be configured through the signal control module to capture a first eyeball image of a first eye of the user through a first optical waveguide channel provided by the first eyeglass lens structure; and
wherein, when the multifunctional head-mounted device is optionally configured to be worn by the user, the second image sensors are allowed to be configured through the signal control module to capture a second eyeball image of a second eye of the user through a second optical waveguide channel provided by the second eyeglass lens structure.

8. The multifunctional head-mounted device according to claim 7,
wherein the first eyeglass frame structure has a first lens accommodating space and a first surrounding groove communicated with the first lens accommodating space, and the first eyeglass lens structure is detachably accommodated in the first lens accommodating space and limited by the first surrounding groove;
wherein the second eyeglass frame structure has a second lens accommodating space and a second surrounding groove communicated with the second lens accommodating space, and the second eyeglass lens structure is detachably accommodated in the second lens accommodating space and limited by the second surrounding groove;
wherein the first eyeglass lens structure includes a first lens, a first external reflective layer disposed on a first outer surface of the first lens, and a first internal reflective layer disposed on a first inner surface of the first lens;
wherein the second eyeglass lens structure includes a second lens, a second external reflective layer disposed on a second outer surface of the second lens, and a second internal reflective layer disposed on a second inner surface of the second lens;
wherein the first image generating chips and the first image sensors are sequentially arranged on a first circuit substrate to surround the first lens of the first eyeglass lens structure, and the first circuit substrate is circumferentially disposed inside or outside the first surrounding groove;
wherein the second image generating chips and the second image sensors are sequentially arranged on a second circuit substrate to surround the second lens of the second eyeglass lens structure, and the second circuit substrate is circumferentially disposed inside or outside the second surrounding groove;
wherein, when the first image sensors are configured to capture the first eyeball image of the first eye of the user, the first eyeball reflected light generated from the first eye is reflected multiple times between the first external reflective layer and the first internal reflective layer of the first eyeglass lens structure and then is projected onto the first image sensors; and
wherein, when the second image sensors are configured to capture the second eyeball image of the second eye of the user, the second eyeball reflected light generated from the second eye is reflected multiple times between the second external reflective layer and the second internal reflective layer of the second eyeglass lens structure and then is projected onto the second image sensors.

9. The multifunctional head-mounted device according to claim 6,
wherein the first eyeglass frame structure has a first lens accommodating space and a first surrounding groove communicated with the first lens accommodating space, and the first eyeglass lens structure is detachably accommodated in the first lens accommodating space and limited by the first surrounding groove;
wherein the second eyeglass frame structure has a second lens accommodating space and a second surrounding groove communicated with the second lens accommodating space, and the second eyeglass lens structure is detachably accommodated in the second lens accommodating space and limited by the second surrounding groove;
wherein the first eyeglass lens structure includes a first lens, a first external reflective layer disposed on a first outer surface of the first lens, and a first internal reflective layer disposed on a first inner surface of the first lens;
wherein the second eyeglass lens structure includes a second lens, a second external reflective layer disposed on a second outer surface of the second lens, and a second internal reflective layer disposed on a second inner surface of the second lens;
wherein the first image generating chips are surroundingly arranged inside or outside the first surrounding groove, and each of the first image generating chips has a first light-emitting area facing the first lens of the first eyeglass lens structure;
wherein the second image generating chips are surroundingly arranged inside or outside the second surrounding groove, and each of the second image generating chips has a second light-emitting area facing the second lens of the second eyeglass lens structure;
wherein, when the first image generating chips are configured to project the first predetermined image beam onto a first eye of a user, a first predetermined image beam generated by the first image generating chips is reflected multiple times between the first external reflective layer and the first internal reflective layer of the first eyeglass lens structure and then is projected onto the first eye of the user; and
wherein, when the second image generating chips are configured to project a second predetermined image beam onto a second eye of the user, the second predetermined image beam generated by the second image generating chips is reflected multiple times between the second external reflective layer and the second internal reflective layer of the second eyeglass lens structure and then is projected onto the second eye of the user.

10. A method of using a multifunctional head-mounted device, comprising:
providing a multifunctional head-mounted device, wherein the multifunctional head-mounted device includes a device casing module, a signal control module disposed in the device casing module, a first image generating module electrically connected to the signal control module, and a second image generating module electrically connected to the signal control module;
projecting a first predetermined image beam generated by the first image generating module onto a first eye of a user through an optical waveguide transmission provided by the device casing module; and
projecting a second predetermined image beam generated by the second image generating module onto a second eye of the user through the optical waveguide transmission provided by the device casing module;
wherein the device casing module includes a first eyeglass frame structure, a second eyeglass frame structure cooperating with the first eyeglass frame structure, a first eyeglass lens structure carried by the first eyeglass frame structure, and a second eyeglass lens structure carried by the second eyeglass frame structure;
wherein the first image generating module includes a plurality of first image generating chips, and the plurality of first image generating chips are configured to surround the first eyeglass lens structure and be surrounded by the first eyeglass frame structure;
wherein the second image generating module includes a plurality of second image generating chips, and the plurality of second image generating chips are configured to surround the second eyeglass lens structure and be surrounded by the second eyeglass frame structure;
wherein, when the multifunctional head-mounted device is optionally configured to be worn by the user, the plurality of first image generating chips are allowed to be configured through the signal control module to project the first predetermined image beam onto the first eye of the user through a first optical waveguide channel provided by the first eyeglass lens structure; and
wherein, when the multifunctional head-mounted device is optionally configured to be worn by the user, the plurality of second image generating chips are allowed to be configured through the signal control module to project the second predetermined image beam onto the second eye of the user through a second optical waveguide channel provided by the second eyeglass lens structure.
